(19) United States
(12) Patent Application Publication
(10) Pub. No.: US 2025/0097564 A1
(43) Pub. Date: Mar. 20, 2025

(54) INTEGRATING IMAGE OF PERSONS MISSING FROM AN IMAGE CAPTURED BY AN ELECTRONIC DEVICE

(71) Applicant: MOTOROLA MOBILITY LLC, WILMINGTON, DE (US)

(72) Inventors: AMIT KUMAR AGRAWAL, BANGALORE (IN); RAHUL BHARAT DESAI, HOFFMAN ESTATES, IL (US); RAUL DELEGA RAMOS, CAMPINAS (BR); JOSE DOUGLAS BERTAZZONI ZAMBIANCO, TAQUARAL (BR)

(21) Appl. No.: 18/468,692

(22) Filed: Sep. 16, 2023

(51) Int. Cl. H04N 23/611; G06V 10/70; G06V 10/74; G06V 40/10; H04N 5/262; H04N 5/265; H04N 23/62; H04N 23/63; H04N 23/667

(52) U.S. Cl. CPC H04N 23/611; G06V 10/70; G06V 10/761; G06V 40/10; H04N 5/2628; H04N 5/265; H04N 23/62; H04N 23/631; H04N 23/667

(57) ABSTRACT

An electronic device, a method and a computer program product for integrating a non-contemporaneously captured image of a person to a device captured image. The method includes detecting, via a processor, activation of a camera to capture an image and identifying a first individual within a first preliminary image. The method further includes determining if a second individual is missing from the first preliminary image based on a comparison of individuals identified within the first preliminary image to a group of individuals that are normally associated with the first individual. In response to determining that the second individual is absent or missing from the first preliminary image, the method further includes presenting on a display a graphical user interface that contains a user-selectable option to enable a missing image mode to electronically add an image of the missing second individual to the captured image.

### BACKGROUND

### 1. Technical Field

The present disclosure generally relates to electronic devices with cameras and in particular to capturing images using an electronic device.

### 2. Description of the Related Art

Electronic devices, such as cell phones, tablets, and laptops, are widely used for communication and data transmission. These electronic devices typically include one or more cameras that are used for taking pictures and videos. Many conventional electronic devices have multiple front and rear cameras. It is common for electronic device users to take photos of groups of people such as family members and friends. Often, during the capture of a photo, a group of people can be missing one or more individuals that are typically part of the group. For example, a mother may currently be missing from a family of four that want to take a photo, where only the father, son, and daughter are present at that occasion. In another example, of a group of three friends who usually take photographs together, only two members are present to take a group photo at their current location. Unfortunately, the third friend is not present at the time and is then visibly missing from the resulting photo.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2A is an example illustration of the front of an electronic device with multiple front cameras, according to one or more embodiments;

FIG. 2B is an example illustration of the rear of an electronic device with multiple rear cameras, according to one or more embodiments;

FIG. 3 is a block diagram of example contents of the system memory of the example electronic device of FIG. 1, according to one or more embodiments;

FIG. 4 is an example illustration of an electronic device using a missing image mode (MIM) to add a missing individual to an image, according to one or more embodiments;

FIG. 5 illustrates image preview content presented on a display of the electronic device of FIG. 4, after a preliminary image has been captured, according to one or more embodiments;

FIG. 6A is an example previous image, including a face and torso of an individual missing from the preliminary image, according to one or more embodiments;

FIG. 6B is an example cropped image remaining after the missing individual has been cropped from other individuals and a background of the image of FIG. 6A, according to one or more embodiments;

FIG. 7 illustrates new image preview content presented on a display of the electronic device of FIG. 5, after the cropped image of from FIG. 6B has been integrated into the preliminary image to generate a composite image, according to one or more embodiments;

FIG. 8 depicts a flowchart of a method by which an electronic device determines that at least one individual is absent or missing from a captured image and presents a missing image mode (MIM) option to add the missing at least one individual to the preliminary image, according to one or more embodiments;

FIG. 9 depicts a flowchart of a method by which an electronic device integrates an image of an absent or missing individual to a preliminary image using the missing image mode to generate a composite image, according to one or more embodiments;

FIG. 10 depicts a flowchart of a method by which an electronic device uses an image context to identify a previous image that contains an absent or missing individual for cropping from the previous image, according to one or more embodiments;

FIG. 11 depicts a flowchart of a method by which an electronic device identifies a specific group of individuals from among a plurality of groups of individuals, according to one or more embodiments; and

FIG. 12 depicts a flowchart of a method by which an electronic device identifies a non-primary user of the electronic device and prevents the non-primary user from integrating an image of a missing person, according to one or more embodiments.

### DETAILED DESCRIPTION

According to one aspect of the disclosure, the illustrative embodiments provide an electronic device, a method, and a computer program product for integrating a non-contemporaneously captured image of a person into a device captured image. In a first embodiment, an electronic device includes a display, at least one camera, and a memory having stored thereon a missing image integration module (MIIM) for integrating a non-contemporaneously captured image of a person to a device captured image. The electronic device includes at least one processor communicatively coupled to the display, the at least one camera, and the memory. The at least one processor executes program code of the MIIM, which enables the electronic device to detect activation of the at least one camera to capture a first preliminary image within a field of view of the at least one camera and to identify at least one first individual within the first preliminary image. The at least one processor determines if at least one second individual is missing from the first preliminary image, based on a comparison of individuals identified within the first preliminary image to a first group of individuals that are normally associated with the at least one first individual. In response to determining that the at least one second individual is missing from the first preliminary image, the at least one processor presents on the display, a graphical user interface (GUI) that contains a user-selectable option to enable a missing image mode to electronically integrate an image of the missing at least one second individual into the first image.

According to another embodiment, the method includes detecting, via at least one processor, activation of at least one camera to capture a first preliminary image within a field of view of the at least one camera and identifying at least one first individual within the first preliminary image. The method further includes determining if at least one second individual is missing from the first preliminary image, based on a comparison of individuals identified within the first preliminary image to a first group of individuals that are normally associated with the at least one first individual. In response to determining that the at least one second individual is missing from the first preliminary image, the method further includes presenting, on a display, a graphical user interface that contains a user-selectable option to enable a missing image mode to electronically integrate an image of the missing at least one second individual into the first image.

According to an additional embodiment, a computer program product includes a computer readable storage device having stored thereon program code that, when executed by at least one processor of an electronic device having a display and at least one camera, the program code enables the electronic device to complete the functionality of one or more of the above described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

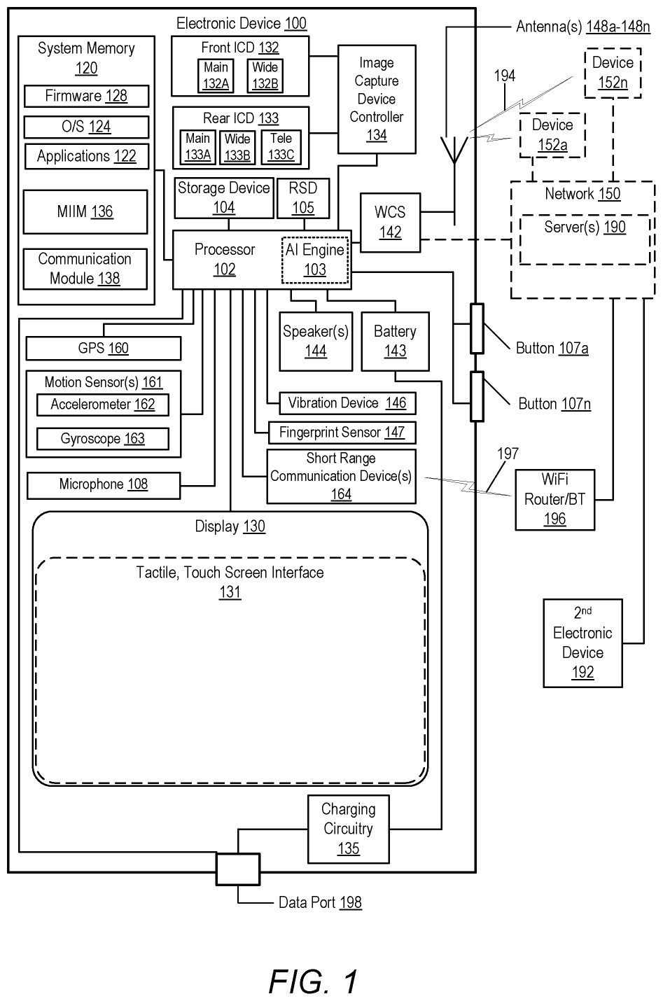

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer and a communication device, etc. It is appreciated that electronic device 100 can be other types of devices that include both at least one front camera and/or multiple rear camera(s). Electronic device 100 includes processor 102. which is communicatively coupled to storage device 104, system memory 120, input devices, (introduced below), output devices, such as display 130, and image capture device (ICD) controller 134. Processor 102 can include processor resources such as a central processing unit (CPU) that support computing, classifying, processing and transmitting of data and information. Processor 102 can further include graphic processing units (GPU) and digital signal processors (DSP) that also support computing, classifying, processing and transmitting of data and information. Processor 102 can further include a hardware based artificial intelligence (AI) engine 103. AI engine 103 accelerates artificial intelligence and machine learning applications. AI engine 103 can also be implemented as a software module.

According to one or more embodiments, ICD controller 134 performs or supports functions such as, but not limited to, operating multiple cameras, adjusting camera settings and characteristics (shutter speed, f/stop, ISO exposure, zoom control, etc.) of the multiple cameras, etc. ICD controller 134 can perform these functions in response to commands received from processor 102, which is executing missing image integration module (MIIM) 136. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102.

System memory 120 may be a combination of volatile and non-volatile memory, such as random access memory (RAM) and read-only memory (ROM). System memory 120 can store program code or similar data associated with firmware 128, an operating system 124, applications 122, missing image integration module (MIIM) 136, and communication module 138. MIIM 136 includes program code that is executed by processor 102 to enable electronic device 100 to integrate a non-contemporaneously captured image of a person to an image captured by the ICD of the electronic device. Communication module 138 includes program code that is executed by processor 102 to enable electronic device 100 to communicate with other external devices and systems.

Although depicted as being separate from applications 122, MIIM 136 and communication module 138 may be each implemented as an application. Processor 102 loads and executes program code stored in system memory 120. Examples of program code that may be loaded and executed by processor 102 include program code associated with applications 122 and program code associated with MIIM 136 and communication module 138.

In one or more embodiments, electronic device includes removable storage device (RSD) 105, which is inserted into an RSD interface (not shown) that is communicatively coupled via system interlink to processor 102. In one or more embodiments, RSD 105 is a non-transitory computer program product or computer readable storage device. RSD 105 may have a version of MIIM 136 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Throughout the disclosure, the term image capturing device is utilized interchangeably to be synonymous with and/or refer to any one of front or rear cameras 132, 133. Front cameras (or image capture device (ICD)) 132 are communicatively coupled to ICD controller 134, which is communicatively coupled to processor 102. ICD controller 134 supports the processing of signals from front cameras 132. Front cameras 132 can each capture images that are within the respective field of view (FOV) of image capture device 132. Electronic device 100 includes several front cameras 132. First front camera 132A is a main camera that captures a standard angle FOV. Second front camera 132B is wide angle camera. Front cameras 132A and 132B can be collectively referred to as front cameras 132A-132B. While two front cameras 132A-132B are shown, electronic device 100 can have more than two front cameras.

Electronic device 100 further includes several rear cameras 133. Main rear camera 133A captures a standard or regular angle FOV. Wide angle rear camera 133B is captures a wide angle FOV. Telephoto rear camera 133C captures a telephoto FOV (zoom or magnified). While three rear cameras are shown, electronic device 100 can have less than three rear cameras, such as having one or two rear cameras, or can have more than three rear cameras.

Each front camera 132A and 132B and each rear camera 133A, 133B and 133C is communicatively coupled to ICD controller 134, which is communicatively coupled to processor 102. ICD controller 134 supports the processing of signals from front cameras 132A and 132B and rear cameras 133A, 133B and 133C. Front cameras 132A and 132B can be collectively referred to as front cameras 132, and rear cameras 133A, 133B and 133C can be collectively referred to as rear cameras 133, for simplicity.

Electronic device 100 can further include data port 198, charging circuitry 135, and battery 143. Electronic device 100 further includes microphone 108, one or more output devices such as speakers 144, and one or more input buttons 107a-n. Input buttons 107a-n may provide controls for volume, power, and image capture devices 132, 133. Microphone 108 can also be referred to as audio input device 108. Microphone 108 and input buttons 107a-n can also be referred to generally as input devices.

Electronic device 100 further includes wireless communication subsystem (WCS) 142, which is coupled to antennas 148a-148n. In one or more embodiments, WCS 142 can include a communication module with one or more baseband processors or digital signal processors, one or more modems, and a radio frequency front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150. In one embodiment, communication network devices 152a-152n contain electronic communication equipment to enable communication with electronic device 100.

Wireless network 150 further allows electronic device 100 to wirelessly communicate with second electronic devices 192, which can be similarly connected to wireless network 150 via one of network communication devices 152a-152n. Wireless network 150 is communicatively coupled to wireless fidelity (WiFi) router 196. Electronic device 100 can also communicate wirelessly with wireless network 150 via communication signals 197 transmitted by short range communication device(s) 164 to and from WiFi router 196, which is communicatively connected to network 150. In one or more embodiment, wireless network 150 can include one or more servers 190 that support exchange of wireless data and video and other communication between electronic device 100 and second electronic device 192.

Electronic device 100 further includes short range communication device(s) 164. Short range communication device 164 is a low powered transceiver that can wirelessly communicate with other devices. Short range communication device(s) 164 can include one or more of a variety of devices, such as a near field communication (NFC) device, a Bluetooth device, and/or a wireless fidelity (Wi-Fi) device. Short range communication device(s) 164 can wirelessly communicate with WiFi router/Bluetooth (BT) device 196 via communication signals 197. In one embodiment, electronic device 100 can receive internet or Wi-Fi based calls via short range communication device(s) 164. In one embodiment, electronic device 100 can communicate with WiFi router/BT 196 wirelessly via short range communication device(s) 164. In an embodiment, WCS 142, antennas 148a-148n and short-range communication device(s) 164 collectively provide communication interface(s) of electronic device 100. These communication interfaces enable electronic device 100 to communicatively connect to at least one second electronic device 192 via at least one network.

Electronic device 100 further includes vibration device 146, fingerprint sensor 147, global positioning system (GPS) device 160, and motion sensor(s) 161. Vibration device 146 can cause electronic device 100 to vibrate or shake when activated. Vibration device 146 can be activated during an incoming call or message in order to provide an alert or notification to a user of electronic device 100. According to one aspect of the disclosure, display 130, speakers 144, and vibration device 146 can generally and collectively be referred to as output devices.

Fingerprint sensor 147 can be used to provide biometric data to identify or authenticate a user. GPS device 160 can provide time data and location data about the physical location of electronic device 100 using geospatial input received from GPS satellites.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100.

In the description of each of the following figures, reference is also made to specific components illustrated within the preceding figure(s). Similar components are presented with the same reference number.

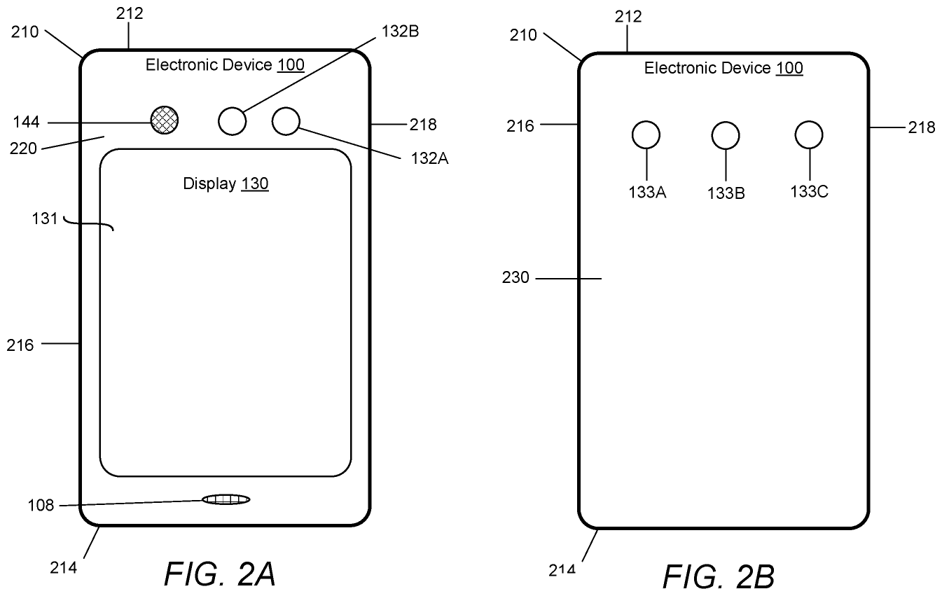

Turning to FIG. 2A, additional details of the front surface of electronic device 100 are shown. Electronic device 100 includes a housing 210 that contains the components of electronic device 100. Housing 210 includes a top 212, bottom 214, and opposed sides 216 and 218. Housing 210 further includes a front surface 220. Microphone 108, display 130, front cameras 132A, 132B and speaker 144 are located on/at front surface 220.

With additional reference to FIG. 2B, additional details of the rear surface 230 of housing 210 of electronic device 100 are shown. Various components of electronic device 100 are located on/at rear surface 230, including rear cameras 133. Rear main camera 133A, rear wide angle camera 133B, and rear telephoto camera 133C are illustrated located on/at rear surface 230. Each of the multiple rear facing cameras can have different image capturing characteristics. For example, rear facing telephoto camera 133C can include an optical zoom lens that is optimized for capturing images of distant objects.

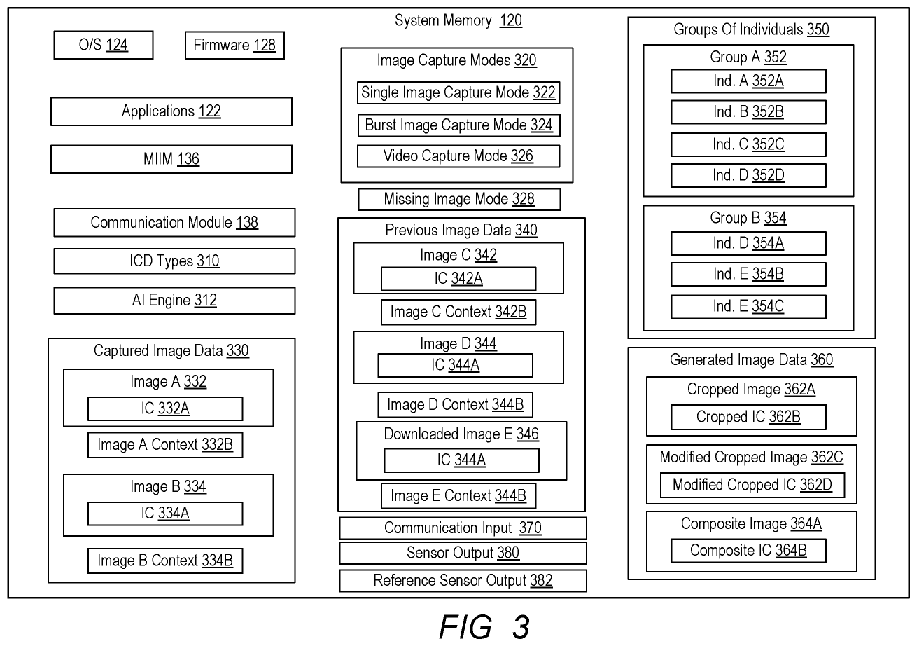

Referring to FIG. 3, there is shown one embodiment of example contents of system memory 120 of electronic device 100. System memory 120 includes data, software, and/or firmware modules, including applications 122, operating system 124, firmware 128, MIIM 136, and communication module 138.

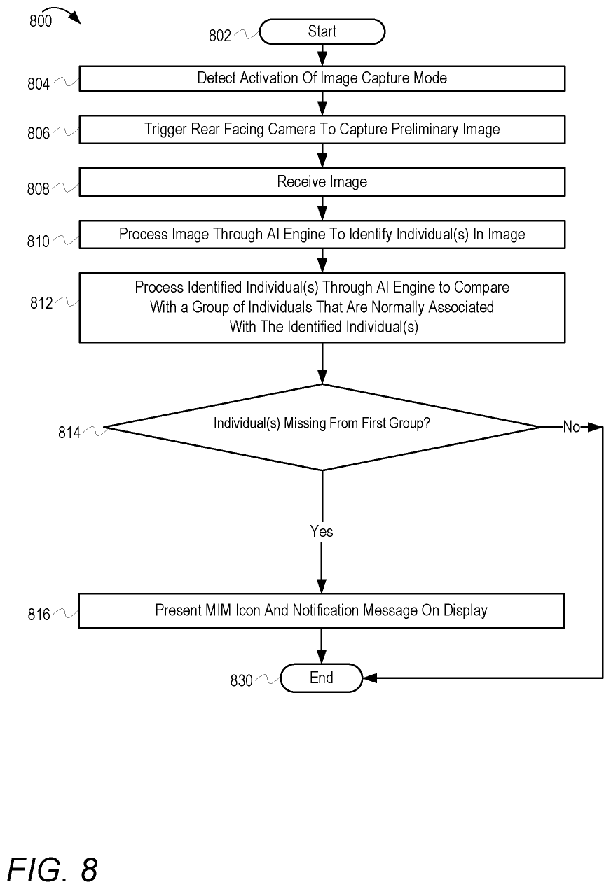

MIIM 136 includes program code that is executed by processor 102 to enable electronic device 100 to perform the various features of the present disclosure. In one or more embodiments, MIIM 136 enables electronic device 100 to integrate a non-contemporaneously captured image of a person into a current or preliminary image captured by the electronic device. In one or more embodiments, execution of MIIM 136 by processor 102 enables/configures electronic device 100 to perform the processes presented in the flowcharts of FIGS. 8-12, as will be described below.

System memory 120 further includes image capture modes 320. Image capture modes 320 are modes of operation that can be used with each of the front cameras 132A-133B and rear cameras 133A-133C. The examples presented of image capture modes 320 comprise single image capture mode 322, burst image capture mode 324, and video capture mode 326.

In one embodiment, a user can select one of the front cameras 132A-133B or rear cameras 133A-133C as the active camera and then can select one of the image capture modes for use with the selected camera. Single image capture mode 322 enables electronic device 100 to capture a single image. In one or more embodiments, single image capture mode 322 is a default mode setting for the image capture. Burst image capture mode 324 enables electronic device 100 to capture a sequential series of images. For example, electronic device 100 can capture an image every half a second for 5 seconds for a total of 10 captured images. Video capture mode 326 enables electronic device 100 to capture video data using the selected active camera.

System memory 120 further includes missing image mode (MIM) 328 that enables electronic device 100 to integrate a non-contemporaneously captured image of a person to an electronic device captured image using at least one of front cameras 132A-133B and at least one of rear cameras 133A-133C and generate a composite image. MIM 328 enables electronic device 100 to capture a first preliminary image using at least one of front cameras 132A-133B or at least one of rear cameras 133A-133C and to identify at least one first individual in the first preliminary image. MIM 328 further enables electronic device 100 to identify that at least one second individual is absent or missing from the first preliminary image of the camera based on a comparison of individuals identified within the first preliminary image to a first group of individuals that are normally associated with the at least one first individual. MIM 328 further enables electronic device 100 to electronically integrate an image of the absent or missing at least one second individual into the first image to generate a first composite image. In one embodiment, an absent or missing person is one or more person(s) that are missing from the preliminary image who are normally included in captured images that present the other persons in the captured image. It is appreciated that other types of modes can be defined for use by the electronic device 100, and that those additional modes fall within the scope of the disclosure.

Communication module 138 enables electronic device 100 to communicate with wireless network 150 and with other devices, such as second electronic device 192, via one or more of audio, text, and video communications.

System memory 120 further includes camera or ICD types 310, and artificial intelligence (AI) engine 312. ICD types 310 contain information identifying the specific front and rear cameras 132A, 132B, 133A, 133B and 133C that are included in electronic device 100 and settings/parameters of each camera.

AI engine 312 enables electronic device 100 to associate individuals identified within a preliminary image of at least one camera with at least one of a plurality of groups of individuals who are normally photographed together and assign each of the individuals identified within the current image to at least one of the plurality of groups of individuals. AI engine 312 further enables electronic device 100 to identify a first group of individuals from among the assigned groups of individuals based on an analysis by AI engine 312 of which group a majority of the individuals in a current or preliminary image are associated with. AI engine 312 further enables electronic device to identify which person is missing from the current image based on a comparison of the faces within the current image and the selected first group of individuals in a previous reference image of the first group of individuals. AI engine 312 and/or hardware-based AI engine 103 can perform/support the same operations.

AI engine 103/312 then enables electronic device 100 to locate a previous image containing at least the face of the person missing from the current image. In one or more embodiment, the located previous image is selected from among previous images to include or present the person in a context that is similar (within a threshold variance) to the context of the current image. If the context includes a full body view of the other persons in the current image, the AI engine 103/312 locates a previous image that includes the person's face and body (or relevant parts of the person's connected torso). If the context is a beach motif, AI engine 312 locates a previous image that includes the person in a beach (or pool or open water related) motif. AI engine 103/312 further enables electronic device 100 to identify the person's face and body and a background in a selected previous image and to remove the background from the person's face and body or vice versa to generate a cropped image of the person without the background or surrounding parts of the previous image (i.e., with the background removed). In one embodiment, AI engine 103/312 can use image segmentation technology/methods to divide an image into multiple segments that each represents a specific object or area of interest. AI engine 103/312 can analyze the segments to locate one or more faces (or image of the person) and generate a cropped (or face plus torso/body) image.

System memory 120 further includes captured image data 330 and previous image data 340. Captured image data 330 are images currently captured by at least one of front facing cameras 132A-132B and/or at least one of rear cameras 133A-133C during current image capture by an electronic device user. Example captured image data 330 includes one or more images, such as image A 332 and image B 334. Image A 332 includes image characteristics (IC) 332A. Image B 334 includes IC 334A. IC 332A and 334A are attributes identified as associated with each of their respective images and can be used to adjust subsequently rendered or generated images. For example, IC 332A and 334A can include light levels, light direction, exposure, white balance, focal distances, distances to objects, and directions to objects. Captured image data 330 further includes image A context 332B and image B context 334B. Image A context 332B and image B context 334B are the setting, scene, or background associated with each of their respective images and can be used to determine or assess if images are appropriate to be combined into a composite image. For example, image A context 332B and image B context 334B can include scene descriptors such as a beach scene or family gathering scene.

Previous image data 340 includes images previously captured by at least one of front facing cameras 132A-132B and/or at least one of rear cameras 133A-133C during a previous image capture by an electronic device user and/or other previous images that were captured by a different device and are locally stored on device storage. In one or more embodiments, other previous images can be downloaded from an image data store or other device having an original/copy of the other previous image. Example captured image data 340 includes one or more images, such as image C 342, image D 344, and downloaded image E 346. Image C 342 includes IC 342A. Image D 344 includes IC 344A. Downloaded image D 344 includes IC 346A. Previous image data 330 further includes image C context 342B, image D context 344B and image E context 346B.

System memory 120 further includes identifying data for individuals within at least one group of associated individuals 350. Each of the groups of associated individuals 350 include two or more identified individuals that have been known to associate together. Groups of associated individuals 350 include group A 352 and group B 354. Group A 352 includes individuals 352A, 352B, 352C, and 354D. Group B 354 includes individuals 354A, 354B, and 354C. In one embodiment, AI engine 103/312 can form groups of associated individuals 350 over a period of time based on facial recognition to identify individuals in previous image data 340 and can assign each individual to one of groups 352 or 354 based on a clustering analysis of which individuals most frequently associate with each other. The groups of associated individuals 350 are used in identifying if an individual in a captured image is missing from the group.

System memory 120 further includes generated image data 360. Generated image data 360 includes images that are generated by electronic device 100 based on captured image data 330 and combinations/integrations of captured image data 330 and portions of previous image data 340. Example generated image data 360 includes one or more images such as cropped image 362A, modified cropped image 362C, and first composite image 364A. Cropped image 362A includes cropped IC 362B. Modified cropped image 362C includes modified cropped IC 362D. First composite image 364A includes first composite IC 364B.

System memory 120 further includes communication input 370 and sensor output 380 and reference sensor output 382. Communication input 370 is speech of one or more individuals that is detected by microphone 108. Communication input 370 can be used to identify an individual that is missing from an image. Sensor output 380 is output received from at least one sensor device of electronic device 100 (i.e., front cameras 132A-132B, microphone 108 and fingerprint sensor 147). Reference sensor output 382 corresponds to an authenticated sensor output associated with a primary user of electronic device 100. Reference sensor output 382 can be used to identify if electronic device 100 is being operated by a primary user or non-primary user (i.e., a secondary user). In one embodiment, reference sensor output 382 can be an image of the face of the primary user or can be the fingerprint of the primary user or can be a recording of the voice of the primary user.

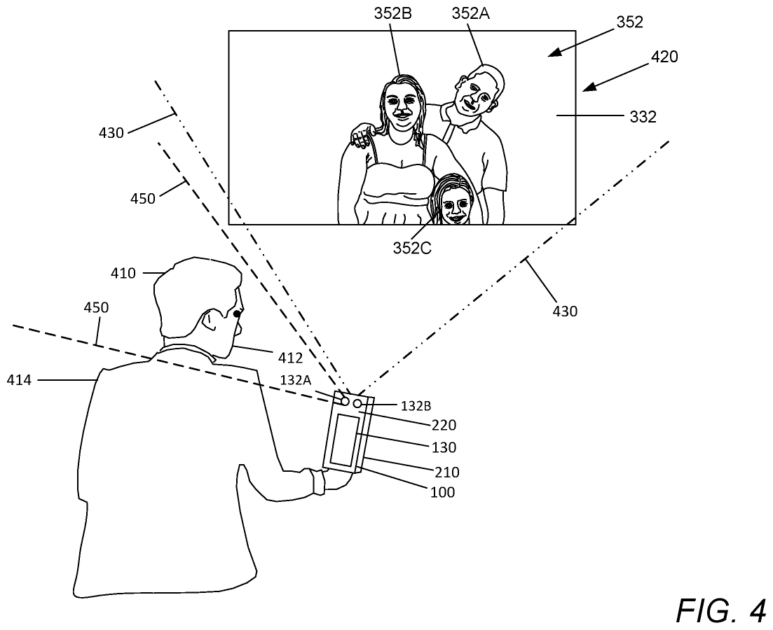

FIG. 4 illustrates electronic device 100 being used to take a group photograph or group image capture of a group of individuals. Referring to FIG. 4, electronic device 100 has been positioned by the electronic device user 410 such that the front cameras 132A-132B face electronic device user 410 and the rear cameras 133A-133C face region of interest (ROI) 420 including at least a portion of group A 352 of individuals within a field of view (FOV) 430. The active rear camera (i.e., rear camera 133A) has a FOV 430 that captures image A 332 containing at least a portion of group of individuals A 352. Front camera 132A has a FOV 450 that captures image B 334 containing the face 412 and a portion of torso 414 of user 410.

In one embodiment, image A 332 can be a preliminary image that is automatically captured by one or more cameras of electronic device 100 after at least one camera has been selected for use or after one of the image capture modes 320 has been selected. Using a family analogy for the example image being captured, image A 332 is shown including a family of individuals, such as individual A (father) 352A, individual B (mother) 352B and individual C (child) 352C. Electronic device 100 can use the preliminary image (i.e., image A 332) to identify individuals in the image and to determine a context of the image. In one example embodiment, electronic device 100 can perform facial and scene recognition on image A 332 to identify individuals and provide a description of the image context 332B of image A 332.

According to one aspect of the disclosure, when attempting to capture a group image, electronic device 100 can perform facial recognition of image A 332 and identify at least one first individual (e.g. individual A 352A) within the first preliminary (i.e., image A 332) and determine if at least one second individual (e.g. individual D 352D (FIG. 3)) is missing from the captured image, based on a comparison of individuals identified within the captured image to a first group of individuals (e.g. group A 352) that are normally associated with the at least one first individual (e.g. individual A 352A).

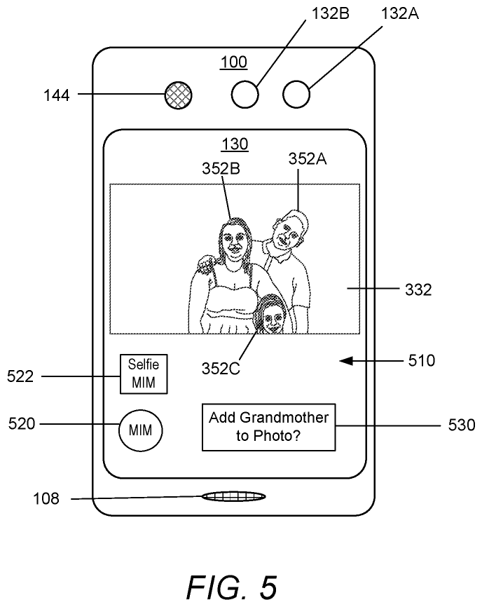

Referring to FIG. 5, electronic device 100 is illustrated with an example GUI 510 containing a preliminary image (i.e., image A 332) presented on display 130. In one embodiment, the preliminary image can be a viewfinder view that presents the preliminary image on display 130. Image A 332 can also be referred to as a current image being captured by an active camera of electronic device 100. Electronic device 100 can determine that at least one second individual (e.g. individual D 352D (FIG. 3)) is missing from the preliminary image, based on a comparison of individuals identified in the preliminary image to a first group of individuals (e.g. group A 352) that are normally associated with the at least one first individual (e.g. individual A 352A). After determining that at least one second individual is missing from the preliminary image A 332, GUI 510 can present a user-selectable option, missing image mode (MIM) option 520, for electronic device user 410 to select to add the missing individual to image A 332. In an alternative embodiment, GUI 510 can further present a user-selectable option, selfie MIM option 522, for electronic device user 410 to select to add an image of themselves from a previous captured image as the missing individual to the preliminary image A 332.

The selection of MIM option 520 triggers the activation of MIM mode 328 to electronically add an image of the missing at least one second individual to image A 332. In one embodiment, GUI 510 can further present a notification message 530 of the identity of the missing individual in image A 332 that is missing from the group of individuals (e.g. group A 352) and prompt for the selection of MIM option 520 to add the missing person to the photograph. In FIG. 5, notification message 530 indicates that the identity of the missing individual in image A 332 is a grandmother (i.e., individual D 352D).

In one embodiment MIM option 520 can be set as a default mode of operation for electronic device 100 to automatically add an image of the missing at least one second individual to the preliminary image. When MIM option 522 is set as the default mode, electronic device 100 can determine that the second individual is missing from the preliminary image and automatically add an image of the missing at least one second individual from a previous image to the preliminary image without user input.

The selection of selfie MIM option 522 triggers the activation of MIM mode 328 to electronically add an image of the missing electronic device user 410 to image A 332. When the missing at least one second individual is the electronic device user that is using electronic device 100, activation of MIM mode 328 causes an image of the electronic device user to be cropped from a previous image and integrated into the preliminary image to form a composite image.

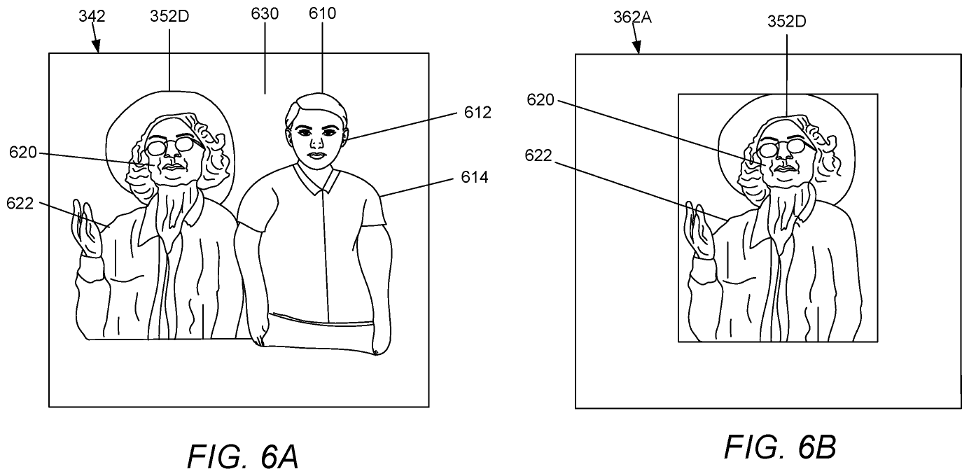

With reference now to FIG. 6A, an example previous image C 342 is illustrated. Previous image C 342 can be captured by at least one of front cameras 132A-132B or rear cameras 133A-133C and stored within electronic device storage. Previous image C 342 includes individual D 352D (i.e., grandmother) and another individual 610. Individual 610 has a face 612 and a torso 614. Individual D 352D has a face 620 and a torso 622. Previous image C 342 further includes a background 630 with tress and a skyline. According to one aspect of the disclosure, MIIM 136 enables electronic device 100 to processes the previous image C 342 through artificial intelligence engine 103/312. AI engine 103/312 identifies grandmother's face 620, torso 614, included with other content, individual 610 and background 630, in the previous image C 342. MIIM 136 further enables electronic device 100 to remove the individual 610 and background 630 from the previous image C 342 to generate edited or cropped image 362A based on the remaining face 620 and torso 622 of the grandmother.

Turning to FIG. 6B, an example edited or cropped image 362A of the grandmother is illustrated after individual 610 and background 630 has been removed. In FIG. 6B, the individual 610 and background 630 have been removed from previous image C 342 leaving face 620 and torso 622 of individual D 352D (i.e., grandmother) remaining in edited or cropped image 362A.

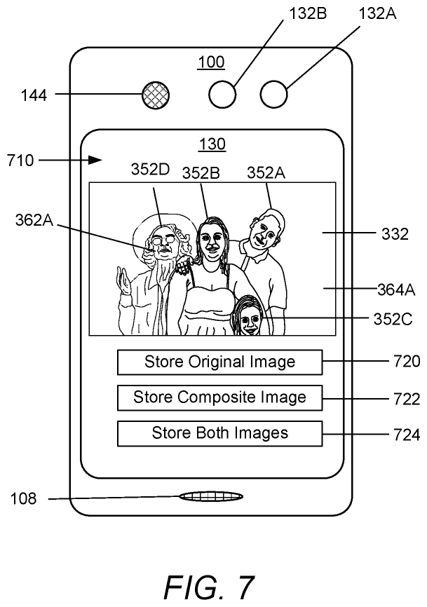

Referring to FIG. 7, electronic device 100 is illustrated with an example GUI 710 containing composite image 364A presented on display 130. Composite image 364A is generated by superimposing cropped image 362A onto the current or preliminary image A 332. Composite image 364A includes image A 332 with the superimposed cropped image 362A. Cropped image 362A is integrated into image A 332 to generate composite image 364A. In FIG. 7, individual D 352D (i.e., grandmother) has been added to image A 332 such that all of the normal family members of group A 352 are shown in composite image 364A.

While only one missing individual was shown being added to the current image A 332 in the presented illustration(s), electronic device 100 can, in other embodiments, identify that several individuals are missing from a preliminary image and electronically add each of the missing individuals, cropped from one or more previous images, to the preliminary image to generate a composite image that presents all of the normal grouping of individuals. GUI 710 can further present different selectable store image options 720, 722, and 724. Store original image option 720, when selected, stores the original captured image A 332 to system memory 120. Store composite image option 722, when selected, stores only the composite image 364A with the added missing family/group member to system memory 120. Store both images option 724, when selected, stores both captured image A 332 and composite image 364A to system memory 120. It is appreciated that a default setting can be pre-programmed to store both images 332 and 364A as a part of the process of generating composite image 364A.

According to one aspect of the disclosure, MIIM 136 enables electronic device 100 to detect the activation, via processor 102, of rear camera 133A to capture preliminary image A 332 and identify at least one first individual 352A (i.e., father) within the preliminary image. Electronic device 100 further determines if at least one second individual 352D (i.e., grandmother) is missing from the captured image A 332 based on a comparison of individuals identified within the captured preliminary image A 332 to a first group of individuals 352 that are normally associated with the at least one first individual 352A in captured photographs or images. In response to determining that the at least one second individual 352D is missing from the preliminary image A 332, electronic device 100 presents, on display 130, a GUI 510 that contains a user-selectable option (i.e., MIM option 520) to enable MIM 328 to electronically add an image of the missing at least one second individual 352D to the preliminary image A 332.

According to another aspect of the disclosure, after detecting selection of MIM option 328, electronic device 100 (i.e., processor and/or AI) identifies who is missing from the preliminary image and locates a previous image C 342 that includes the person(s) in the appropriate context. Electronic device 100 crops out a cropped image 362A comprising the at least one second individual 352D from the previous image C 342 containing the at least one second individual 352D. Electronic device 100 integrates the edited or cropped image 362A into preliminary image A 332 to generate composite image 364A including the cropped image of the at least one second individual. Electronic device 100 displays the composite image 364A on display 130.

According to an additional aspect of the disclosure, to crop the image from the previous image C 342, MIIM 136 enables electronic device 100 to processes the previous image C 342 through AI engine 103/312, which identifies the at least one second individual 352D and a background 630 in the previous image C 342 and removes the background 630 from the previous image to generate the edited or cropped image 362A (which can be a cropped image, a face on torso image, or a full body image) comprised of the at least one second individual remaining after the background has been removed.

According to one more aspect of the disclosure, MIIM 136 enables electronic device 100 to identify at least one first IC 332A of the first image A 332. Electronic device 100 generates a modified cropped image (i.e., modified cropped image 362C) by adjusting one or more second IC 362B of the cropped image to match the at least one first IC 332A and incorporates the modified cropped image into the first image A 332 to generate the composite image 364A.

According to another aspect of the disclosure, MIIM 136 enables electronic device 100 to identify a first image A context 332B of image A 332 based on characteristics of image A 332 and identify a second image C context 342B of the previous image C 342 containing the at least one second individual, based on characteristics of the previous image C 342. Electronic device 100 determines if the first image A context 332B is substantially similar to the second image C context 342B and in response to determining that the first image A context 332B is substantially similar to the second image C context 342B, selects the previous image C 342 for cropping.

According to one more aspect of the disclosure, MIIM 136 enables electronic device 100 to present on display 130 a GUI 710 that contains user-selectable store image options, 720, 722. and 724, to store one or both of the preliminary image A 332 and the composite image 364A and stores a corresponding one or both of the original image and the composite image based on a received selection.

According to one aspect of the disclosure, MIIM 136 enables electronic device 100 to detect activation of at least one of rear camera 133A-133C and in response to activation of at least one rear camera, electronic device 100 activates at least one input device (i.e., microphone 108) and receives communication input 370 (i.e., speech) from the at least one input device. Electronic device 100 identifies at least one second individual (e.g., individual 352D) that is absent or missing at least partially based on a context of the communication input 370 received from the at least one input device. In an example embodiment, microphone 108 can detect communication input 370 from electronic device user 410 such as, “It would be nice if grandmother was here”. Electronic device 100 can transcribe communication input 370 into text and identify that grandmother (e.g., individual 352D) is absent or missing at least partially based on the context of the communication input 370.

According to yet another aspect of the disclosure, the first group of individuals 352 is one of a plurality of groups of individuals 350 and to identify the first group of individuals 352 among the plurality of groups of individuals 350, MIIM 136 enables electronic device 100 to process the individuals identified within the preliminary image A 332 through AI engine 103/312, which associates the individuals identified within the preliminary image with at least one of the plurality of groups of individuals 350. Electronic device 100 assigns each of the individuals identified within the preliminary image to at least one of the plurality of groups of individuals 350. Electronic device 100 identifies the first group of individuals 352 from among the assigned groups of individuals based on an analysis by AI engine 103/312 of which group a majority of the individuals are associated with to within a threshold certainty.

According to an additional aspect of the disclosure, MIIM 136 enables electronic device 100 to receive a sensor output 380 from the at least one sensor (i.e., front cameras 132A-132B, microphone 108 and fingerprint sensor 147). Electronic device 100 determines if the sensor output 380 is substantially similar to reference sensor output 382 that corresponds to an identity of the primary user of the electronic device. In response to sensor output 380 not being substantially similar to the reference sensor output 382, electronic device 100 disables MIM 328 to prevent a non-primary user of the electronic device from modifying the preliminary image by adding cropped image 362A of the missing at least one second individual to preliminary image A 332.

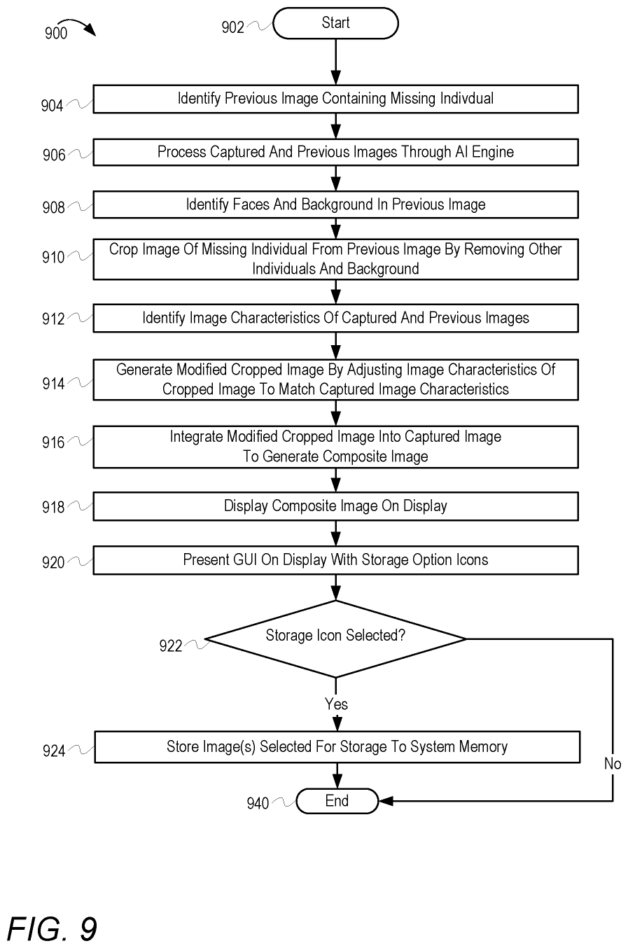

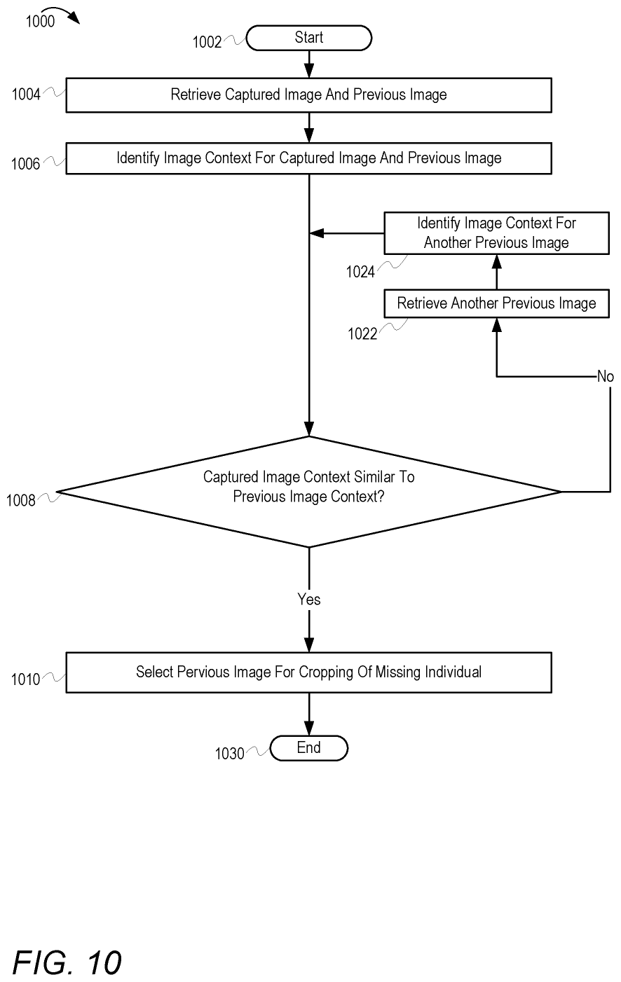

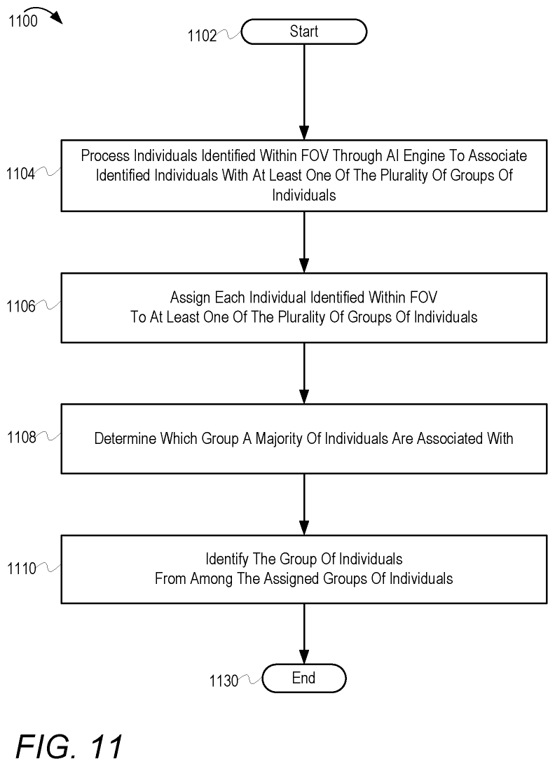

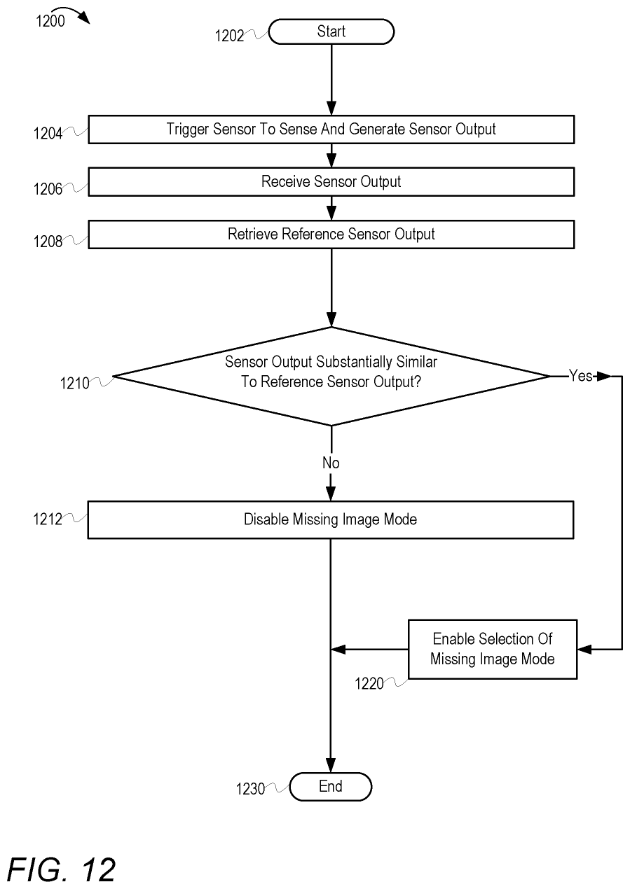

FIG. 8 depicts method 800 by which electronic device 100 determines that at least one individual is absent or missing from a preliminary image and presents a MIM option to add the missing at least one individual to the preliminary image. FIG. 9 depicts method 900 by which electronic device 100 uses MIM 328 to add an image of an absent person and generate a composite image. FIG. 10 depicts method 1000 by which electronic device 100 uses an image context to identify an appropriate previous image that contains a missing individual for cropping from the previous image. FIG. 11 depicts method 1100 by which electronic device 100 identifies a specific group of individuals from among a plurality of groups of individuals to determine which persons are missing from the captured image. FIG. 12 depicts method 1200 by which electronic device 100 identifies a non-primary user of the electronic device and prevents surfacing options for the non-primary user to generated composite images by add an image of a missing person from a previously captured image. The description of methods 800, 900, 1000, 1100, and 1200 will be described with reference to the components and examples of FIGS. 1-7.

The operations depicted in FIGS. 8, 9, 10, 11, and 12 can be performed by electronic device 100 or any suitable electronic device that includes front and rear cameras and the one or more functional components of electronic device 100 that provide/enable the described features. One or more of the processes of the methods described in FIGS. 8-12 may be performed by processor 102 executing program code associated with MIIM 136, and AI engine 103/312.

With specific reference to FIG. 8, method 800 begins at the start block 802. At block 804. processor 102 detects activation of the single image capture mode 332 for at least one of the cameras to capture an image. Processor 102 triggers a camera (e.g., rear camera 133A) to capture a preliminary image A 332 within a FOV 430 of rear camera 133A (block 806), and processor 102 receives the preliminary image A 332 (block 808). Processor 102 processes preliminary image A 332 through artificial intelligence engine 103/312 to identify at least one individual (e.g., individual 352A) within preliminary image A 332 by performing facial recognition on preliminary image A 332 and comparing the identified faces to a database of known individuals (i.e., groups of individuals 350) (block 810).

Processor 102 further processes the identified individuals (e.g., individual 352A) through AI engine 103/312 to compare the identified individuals identified within image A 332 to a first group of individuals 352 that are normally associated with the identified individuals (e.g., individual 352A) (block 812). Processor 102 determines if at least one second individual 352D (e.g., grandmother in a family group) is missing from preliminary image A 332 based on the comparison of individuals identified within the preliminary image A 332 (e.g., individual 352A) to the first group of individuals 352 that are normally associated with the identified individual(s) (individual 352A) (decision block 814).

In response to determining that no second individual 352D is missing from preliminary image A 332, method 800 ends at end block 830. In response to determining that at least one second individual 352D is missing from preliminary image A 332, processor 102 generates and presents on display 130 a GUI 510 that contains a notification message 530 that second individual 352D (i.e., grandmother) is missing from preliminary image A 332 and prompts the electronic device user 410 to select whether to add the missing individual to the captured photograph (e.g., grandmother to the family photograph) in preliminary image A 332. Method 800 includes presenting a selectable MIM option 520, for the electronic device user to select to use MIM 328 to add an image of the missing individual to preliminary image A 332 (block 816). Method 800 then terminates at end block 830.

Referring to FIG. 9, there is presented method 900 by which electronic device 100 adds an image of a missing individual to a preliminary image to generate a composite image after MIM 328 has been selected by an electronic device user (FIG. 8) or after MIM 328 has been selected as a default mode of operation. In one embodiment, when MIM 328 is selected as the default mode of operation, electronic device 100 can automatically add the absent individual(s) to the captured image. Method 900 begins at the start block 902. At block 904, processor 102 identifies the previous image C 342 that contains the second individual 352D that is missing from preliminary image A 332. Aspects of the process for identifying an appropriate previous image is provided within method 1000 of FIG. 10, which is later described.

Processor 102 processes the preliminary image A 332 and the previous image C 342 that contains the second individual 352D through AI intelligence engine 103/312 (block 906), which identifies face 620 and torso 622 of second individual from other individual 610, and background 630 in the previous image C 342 using a segmentation or other process (block 908). Processor 102 extracts a cropped image 362A including a face 620 and torso or a portion of torso 622 of the second individual 352D from the previous image C 342 by removing individual 610 and background 630 from previous image C 342 (block 910). The cropped image 362A comprises the remaining face 620 and portion of torso 622 after individual 610 and background 630 has been removed.

Processor 102 identifies at least one image characteristic 332A of preliminary image A 332 and at least one image characteristic 362B of cropped image 362A (block 912). The image characteristics can include, for example, white balance, exposure, light level and light direction. Processor 102 generates a modified cropped image 362C by adjusting one or more cropped image characteristics 362B of the cropped image to match the at least one image characteristics 332A (block 914).

In one embodiment, processor 102 can use scene-based segmentation analysis to adjust the cropped image characteristics 362B of the cropped image 362A to match the image characteristics 332A of preliminary image A 332 captured by the rear facing camera 133A. In one example embodiment, the brightness and light direction of the cropped image 362A can be adjusted to match the brightness and light direction of preliminary image A 332 such that the modified cropped image 362C with the face and torso of the missing individual 352D appears smoothly integrated, blended or merged with the preliminary image A 332 within the composite image 364A. The resulting composite image 364A, when viewed, appears to be a single image with harmonized image characteristics, and not two separate images.

Processor 102 integrates the modified cropped image 362C onto the preliminary image A332 to generate a first composite image 364A including the missing individual 352D (block 916). Processor 102 temporarily stores first composite image 364A as a second modified version of preliminary image A 332. According to one or more embodiments, processor 102 displays the first composite image 364A on display 130 (block 918). In one embodiment, the first composite image 364A is displayed after the initial image capturing process is completed. Processor 102 generates and presents GUI 710 that contains several selectable storage options 720, 722, and 724 (FIG. 7) (block 920). Store original image option 720, when selected, stores the preliminary image A 332 to system memory 120. Store composite image option 722, when selected, stores composite image 364A with the added missing family member to system memory 120. Store both images option 724, when selected, stores both image A 332 and composite image 364A to system memory 120.

Processor 102 determines if the electronic device user has provided user input by selecting one or more of storage options 720, 722, and 724 using an input device such as touch screen interface 131 (decision block 922). In response to determining that the electronic device user has not selected one of the storage option icons 720, 722, and 724 after expiration of a timeout period, method 900 terminates at end block 940. In response to determining that the electronic device user has selected one of the storage option icons 720, 722, and 724, processor 102 stores the image selected by the user (i.e., preliminary image A 332, or composite image 364A, or both images) to system memory 120 (block 924). In the embodiments in which the composite image is generated and stored as a modified version of the captured image, selection by the user of just the original preliminary image A 332 can trigger deletion of the composite image. In one or more embodiments, instead of the multiple options, where both images are already stored, the presented option(s) can instead provide “delete composite image” option, enabling the user to delete the composite image. Method 900 ends at end block 940.

Referring to FIG. 10, there is presented method 1000 by which electronic device 100 uses an image context to at least partially identify a previous image that contains a missing individual for cropping from the previous image. Method 1000 begins at the start block 1002. At block 1004, processor 102 retrieves preliminary image A 332 and previous image C 342. Processor 102 identifies image context 332B of preliminary image A 332 based on characteristics of the preliminary image A 332 and identifies second image context 342B of the previous image C 342 based on characteristics of the previous image C 342 (block 1006).

Processor 102 determines if the image context 332B is substantially similar to the image context 342B (decision block 1008). In response to determining that image context 332B is substantially similar to image context 342B, processor 102 selects the previous image C 342 containing the missing individual 352D for cropping (block 1010). Method 1000 terminates at end block 1030. In response to determining that the image context 332B is not substantially similar to the image context 342B, processor 102 retrieves another one of the previous images (e.g. image D 344) (block 1020). Processor 102 identifies image context 332D of previous image D 344 based on characteristics of previous image D 344 (block 1022). Processor 102 returns to decision block 1008 to continue determining if the image context 332D of another previous image is substantially similar to the image context 342B. In one embodiment, processor 102 can continue to analyze previous image data 340 until a previous image context is found that is substantially similar to the image context the captured image. However, if no previous image is found (from within the database(s) of stored previous images being accessed by the processor/AI) that provides the required context for integrating a cropped portion thereof into the captured image, method 1000 ends without providing a cropped image, and no composite image is generated.

With reference to FIG. 11, there is presented method 1100 by which electronic device 100 identifies a first group of individuals 352 from among the plurality of groups of individuals 350 found within different previous photographs. Method 1100 begins at the start block 1102. At block 1104, processor 102 process the individuals (e.g., individuals 352A, 352B and 352C) identified within the captured image A 332 through AI engine 103/312, which associates the individuals identified within the captured image with at least one of the plurality of groups of individuals 350. Processor 102 assigns each of the individuals (e.g., individuals 352A, 352B and 352C) identified within the FOV to at least one of the plurality of groups of individuals 350 (block 1106). Processor 102 determines which group among the plurality of groups a majority of the individuals are associated with to within a threshold certainty (block 1108). For example, if there are three individuals in the captured image that are also in a first group of four individuals, while only one or two of the individuals are present in the other groups, then the first group of four individuals are selected, and the processor/AI initiates a search for a previous image that includes the fourth individual from the first group. As another example, if the three individuals are presents in two different groups of four or more individuals, the processor/AI can select the group that has a highest assigned group value by, for example, being more frequently captured together in photographs than the other group. Processor 102 identifies the group of individuals (e.g. group A 352) from among the assigned groups of individuals based on which group a majority of the individuals are associated with and/or most frequently associated with (block 1110). Additionally, the context of the captured picture can also be utilized to identify which group to select to find the missing person. For example, if the first group is often together in a family setting, such as at home or on a vacation or at the beach, and the second group is often together for sporting events, such as at a basketball game or playing soccer, the processor/AI can select the group based on whether the context of the captured image aligns with the family group of the sports group. The missing persons are then identified based on the selected group. Method 1100 terminates at end block 1130.

Referring to FIG. 12, there is presented method 1200 by which electronic device 100 identifies a non-primary user of the electronic device and withholds presenting the GUI with options to enable adding an image of a missing person in order to prevent the non-primary user from triggering automatic addition or manually triggering addition of an image of a missing person to captured images. In one embodiment, method 1200 provides a privacy/security feature that prevents a non-primary user from taking an image of the primary user with electronic device 100 and then viewing the composite image showing/revealing the primary user's family or friends. Method 1200 begins at the start block 1202. At block 1204, processor 102 triggers at least one sensor (i.e., front cameras 132A-132B, microphone 108 and fingerprint sensor 147) to sense corresponding biometric input and generate sensor output 380. Processor 102 receives sensor output 380 from at least one sensor (i.e., front cameras 132A-132B, microphone 108 and fingerprint sensor 147) (block 1206). Processor 102 retrieves reference sensor output 380 from system memory 120 (block 1208).

Processor 102 determines if sensor output 380 is substantially similar to reference sensor output 382 that corresponds to an identity of the primary user of the electronic device (decision block 1210). In response to sensor output 380 not being substantially similar to reference sensor output 382, processor 102 disables MIM 328 to prevent a non-primary user of the electronic device from accessing the features for adding the image (i.e., cropped image 362A) of the missing individual to the captured image A 332 (block 1212). Method 1200 ends at end block 1230.

In response to sensor output 380 being substantially similar to reference sensor output 382, processor 102 enables MIM 328 to be selected by the primary user of the electronic device by selection of MIM icon 520, via touch screen interface 131 or enables MIM 328 when MIM 328 is selected as a default mode of operation (block 1220). Method 1200 terminates at end block 1230.

In the above-described methods of FIGS. 8-12, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
at least one camera;
a memory having stored thereon a missing image integration module (MIIM) for integrating a non-contemporaneously captured image of a person to a device captured image; and
at least one processor communicatively coupled to the display, the at least one camera, and the memory, the at least one processor executing program code of the missing image integration module, which enables the electronic device to:
detect activation of the at least one camera to capture a first image within a field of view of the at least one camera;
identify at least one first individual within a first preliminary image;
determine if at least one second individual is missing from the first preliminary image based on a comparison of individuals identified within the first preliminary image to a first group of individuals that are normally included within captured images comprising the at least one first individual; and
in response to determining that the at least one second individual is missing from the first preliminary image, present on the display a graphical user interface (GUI) that contains a user-selectable option to enable a missing image mode to electronically integrate an image of the missing at least one second individual into the captured first image.

2. The electronic device of claim 1, wherein the at least one processor:
in response to detecting selection of the missing image mode:
identifies a previous image containing the at least one second individual;
crops out an image comprising the at least one second individual from the previous image;
integrates the cropped image into the first preliminary image to generate a first composite image including the cropped image of the at least one second individual; and
displays the first composite image on the display.

3. The electronic device of claim 2, wherein to crop the image from the previous image, the at least one processor:
processes the previous image through an artificial intelligence engine, which identifies the at least one second individual and a background in the previous image; and
removes the background from the previous image to generate the cropped image based on the remaining at least one second individual after the background has been removed.

4. The electronic device of claim 2, wherein the at least one processor:
identifies at least one first image characteristic of the first preliminary image;
generates a modified cropped image by adjusting one or more second image characteristics of the cropped image to match the at least one first image characteristics; and
incorporates the modified cropped image into the first image to generate the first composite image.

5. The electronic device of claim 2, wherein the at least one processor:
identifies a first image context of the first preliminary image based on characteristics of the first image;
identifies a second image context of the previous image based on characteristics of the previous image;
determines if the first image context is substantially similar to the second image context; and
in response to determining that the first image context is substantially similar to the second image context, selects the previous image containing the at least one second individual for cropping.

6. The electronic device of claim 2, wherein the missing at least one second individual is an electronic device user that is using the electronic device and an image of the electronic device user is cropped from the identified previous image to integrate into the first composite image.

7. The electronic device of claim 2, wherein the at least one processor:
presents on the display a GUI that contains a user-selectable option to store one or both of the first preliminary image and the first composite image; and
stores a corresponding one or both of the first preliminary image and the first composite image based on a received selection.

8. The electronic device of claim 1, further comprising:
at least one input device communicatively coupled to the at least one processor; and
the at least one processor:
in response to activation of the first camera, activates the at least one input device;
receives communication input from the at least one input device; and
identifies the at least one second individual at least partially based on a context of the communication input received from the at least one input device.

9. The electronic device of claim 1, wherein the first group of individuals is one of a plurality of groups of individuals and to identify the first group of individuals among the plurality of groups of individuals, the least one processor:
processes the individuals identified within the first preliminary image through an artificial intelligence engine, which associates the individuals identified within the first preliminary image with at least one of the plurality of groups of individuals;
assigns each of the individuals identified within the first preliminary image to at least one of the plurality of groups of individuals; and
identifies the first group of individuals from among the assigned groups of individuals based on an analysis by the artificial intelligence engine of which group a majority of the individuals are associated with to within a threshold certainty.

10. The electronic device of claim 1, further comprising:
at least one sensor communicatively coupled to the at least one processor and which enables identification of a primary user of the electronic device;
wherein the at least one processor:
receives a first sensor output from the at least one sensor;
determines if the first sensor output is substantially similar to a reference sensor output that corresponds to an identity of the primary user of the electronic device; and
in response to the first sensor output not being substantially similar to the reference sensor output, disables the missing image mode to prevent a non-primary user of the electronic device from integrating the image of the missing at least one second individual to the first image.

11. A method comprising:
detecting, via at least one processor, activation of at least one camera to capture a first image within a field of view of the at least one camera;
identifying at least one first individual within a first preliminary image;
determining if at least one second individual is missing from the first preliminary image based on a comparison of individuals identified within the first preliminary image to a first group of individuals that are normally included within captured images comprising the at least one first individual; and
in response to determining that the at least one second individual is missing from the first preliminary image, presenting on a display a graphical user interface (GUI) that contains a user-selectable option to enable a missing image mode to electronically integrate an image of the missing at least one second individual into the first image.

12. The method of claim 11, further comprising:
in response to detecting selection of the missing image mode, identifying a previous image containing the at least one second individual;
cropping out an image comprising the at least one second individual from the previous image;
integrating the cropped image into the first preliminary image to generate a first composite image including the cropped image of the at least one second individual; and
displaying the first composite image on the display.

13. The method of claim 12, wherein to crop the image from the previous image, the method further comprises:
processing the previous image through an artificial intelligence engine, which identifies the at least one second individual and a background in the previous image; and
removing the background from the previous image to generate the cropped image based on the remaining at least one second individual after the background has been removed.

14. The method of claim 12, further comprising:
identifying at least one first image characteristic of the first preliminary image;
generating a modified cropped image by adjusting one or more second image characteristics of the cropped image to match the at least one first image characteristics; and
incorporating the modified cropped image into the first image to generate the first composite image.

15. The method of claim 12, further comprising:
identifying a first image context of the first preliminary image based on characteristics of the first preliminary image;
identifying a second image context of the previous image based on characteristics of the previous image;
determining if the first image context is substantially similar to the second image context; and
in response to determining that the first image context is substantially similar to the second image context, selecting the previous image containing the at least one second individual for cropping.

16. The method of claim 12, wherein the missing at least one second individual is an electronic device user that is using the electronic device and an image of the electronic device user is cropped from the identified previous image to integrate into the first composite image.

17. The method of claim 12, further comprising:
presenting on the display a GUI that contains a user-selectable option to store one or both of the first preliminary image and the first composite image; and
storing a corresponding one or both of the first preliminary image and the first composite image based on a received selection.

18. The method of claim 11, further comprising:
in response to activation of the at least one camera, activating at least one input device;
receiving communication input from the at least one input device; and
identifying the at least one second individual at least partially based on a context of the communication input received from the at least one input device.

19. The method of claim 11, wherein the first group of individuals is one of a plurality of groups of individuals and to identify the first group of individuals among the plurality of groups of individuals, the method further comprises:
processing the individuals identified within the first preliminary image through an artificial intelligence engine, which associates the individuals identified within the first preliminary image with at least one of the plurality of groups of individuals;
assigning each of the individuals identified within the first preliminary image to at least one of the plurality of groups of individuals; and
identifying the first group of individuals from among the assigned groups of individuals based on an analysis by the artificial intelligence engine of which group a majority of the individuals are associated with to within a threshold certainty.

20. A computer program product comprising:
a computer readable storage device having stored thereon program code which, when executed by at least one processor of an electronic device having a display, at least one camera, and a memory, enables the electronic device to complete the functionality of:
detecting activation of the at least one camera to capture a first image within a field of view of the at least one camera;
identifying at least one first individual within a first preliminary image;
determining if at least one second individual is missing from the first preliminary image based on a comparison of individuals identified within the first preliminary image to a first group of individuals that are normally associated with the at least one first individual; and
in response to determining that the at least one second individual is missing from the first preliminary image, presenting on a display a graphical user interface (GUI) that contains a user-selectable option to enable a missing image mode to electronically integrate an image of the missing at least one second individual into the first image.
